(19) United States
(12) Patent Application Publication
(10) Pub. No.: US 2025/0344701 A1
(43) Pub. Date: Nov. 13, 2025

(54) PLANT CUTICLE SUPPLEMENTS AND METHODS AND USE THEREOF

(71) Applicant: OREGON STATE UNIVERSITY, Corvallis, OR (US)

(72) Inventor: Clive Kaiser, Corvallis, OR (US)

(73) Assignee: OREGON STATE UNIVERSITY, Corvallis, OR (US)

(21) Appl. No.: 18/260,579

(22) PCT Filed: Jan. 7, 2022
(86) PCT No.: PCT/US2022/011624

§ 371 Date: Jul. 6, 2023

Related U.S. Application Data
(60) Provisional application No. 63/135,467, filed on Jan. 8, 2021.

(51) Int. Cl. A01N 59/06; A01N 25/04; A01N 25/10; A01N 25/30; A01P 21/00

(52) U.S. Cl. CPC A01N 59/06; A01N 25/04; A01N 25/10; A01N 25/30; A01P 21/00

(57) ABSTRACT

A plant cuticle supplement comprising a cellulose component, one or more oils comprising medium or long chain fatty acids, one or more surfactants, a protic organic solvent, and potassium bentonite. An aqueous composition comprising the plant cuticle supplement and methods of reducing water consumption by a plant and methods for method of reducing egg laying of D. suzukii on a plant using the aqueous composition.

### CROSS-REFERENCE TO RELATED APPLICATION

This application is the US national phase of PCT/US2022/011624, filed on Jan. 7, 2022, which claims the benefit of U.S. Application No. 63/135,467, filed Jan. 8, 2021, each expressly incorporated herein by reference in its entirety.

### BACKGROUND OF THE INVENTION

The plant cuticle is an extracellular hydrophobic layer that covers the aerial epidermis of all land plants. The cuticle plays an important role in maintaining overall crop health and quality. The physiological role of the cuticle extends well beyond its primary function as a transpiration barrier, playing important roles in processes ranging from development to interaction with microbes. In some aspects, plant cuticle functions similarly to human skin, protecting the plant from dehydration as well as serving as a barrier against certain bacteria, fungi, pests, and environmental stresses (Yeats, T. H. and Rose, J.K.C. The Formation and Function of Plant Cuticles. Plant Physiology, September 2013, Vol. 163, pp. 5-20). By thickening the cuticle layer through the application of an exogenous product that can create a cuticle-like coating layer, the impact of plant stressors can be lessened, which can lead to increase in marketable yields and improving fruit quality. Several commercial products are available for this purpose. However, these products suffer from the common drawbacks, as they mostly work to prevent sunburn and do not provide complete plant protection. Some of them, if used too early in the growing season, can even induce sunburn.

There is an existing need for a cuticle supplement that can provide protection from multiple stressors and is easy to apply, suitable for human consumption, and environmentally friendly. The present invention seeks to fulfill this need and provides further related advantages.

### SUMMARY OF THE INVENTION

In one aspect, the invention provides a plant cuticle supplement. In certain embodiments, the plant cuticle supplement, comprises (a) a cellulose component, (b) one or more oils comprising medium or long chain fatty acids, (c) one or more surfactants, (d) a protic organic solvent, and (e) potassium bentonite.

In another aspect, provided herein is a method of treating a plant or a plant part, comprising: contacting the plant or a plant part with the aqueous composition of the disclosure, wherein upon drying of the composition an exogenous film is formed on the plant or a plant part. The plant or a plant part preferably comprises a fruit, flower, leaf or vegetable. In some embodiments, contacting comprises spraying the aqueous composition onto the plant or plant part; dipping the plant or plant part into the aqueous composition, enrobing the plant or plant part with the aqueous composition, or a combination thereof. Preferably, the fruit, flower, leaf or vegetable is attached to a plant or the fruit, flower, or vegetable is post-harvest.

In a further aspect, disclosed herein is a method of reducing water consumption by a plant comprising contacting the plant with the aqueous compositions comprising plant cuticle supplement of the disclosure, wherein upon drying of the composition an exogenous film is formed on the plant thereby reducing water consumption by the plant, for example, an apple, cherry, or grape.

In some embodiments, water consumption is reduced by about 15%, by about 20%, by about 25%, by about 30%, or by about 50%.

Additionally, in another aspect, disclosed herein is a plant or a plant part, e.g., fruit flower or leaf, comprising an exogenous film formed by contacting the plant or plant part with the aqueous composition disclosed herein, wherein the exogenous film forms thereon after drying of the aqueous composition. In some embodiments, the exogenous film does not substantially alter the taste of the plant or plant organ as compared to a substantially equivalent plant or plant organ lacking the exogenous film.

In some embodiments, the exogenous film is suitable for human consumption. The plant or plant part disclosed herein has increased post-harvest shelf life, increased cuticle strength, reduced pre-harvest susceptibility to fungal diseases, or a combination thereof as compared to a substantially equivalent plant in substantially equivalent conditions but lacking the exogenous film.

In certain embodiments, such plant part is fruit, e.g., cherry, blueberry, or grape, that has reduced cracking upon ripening as compared to a substantially equivalent fruit grown in substantially equivalent conditions but lacking the exogenous film.

In some embodiments, the plant, e.g., apple, pear, cherry, wine grape, almond, peach, avocado, or citrus, has reduced water consumption as compared to a substantially equivalent plant in substantially equivalent conditions but lacking the exogenous film.

Additionally, provided herein is a method of reducing egg laying of D. suzukii in a plant, e.g., blueberry, comprising contacting the plant with the aqueous composition disclosed herein, wherein upon drying of the composition an exogenous film is formed on the plant thereby reducing egg laying of D. suzukii in the plant. In some embodiments, the egg laying is reduced by about 60%, about 70%, about 80%, about 90%, or about 95%. Preferably, the reduction of egg laying is found up to 30 days after contacting the plant with the aqueous composition of the disclosure.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIGS. 1 and 2 are tables that show the effectiveness of representative compositions of the invention (PBC-1320 and PBC-1322, respectively), in controlling Rhagoletis indifferens in sweet cherries.

FIG. 3 is a table that summarizes the results of a field spray trial using PBC 1320 and 1322 against western cherry fruit fly infestation of sweet cherry.

FIG. 4 is a table that shows the mean numbers of Rhagoletis indifferens (females and males) seen on cherries per tree over a 1-min observation on three dates in the field on untreated control versus PBC 1320- and PBC 1322-treated trees at an experimental orchard.

### DETAILED DESCRIPTION OF THE INVENTION

Disclosed herein are novel cuticle supplements and methods of their use. The cuticle supplements are useful, among other things, for forming an exogenous film on plants and plant parts. The film can function to protect the plant from damage caused by weather conditions, infestation by organisms, as well as over ripening. Methods of making and using the film and plants and plant parts comprising the film are also provided.

Throughout the specification, the terms “plant cuticle supplement,” “plant cuticle “composition,” “cuticle supplement,” and “cuticle composition” are used interchangeably. In some embodiments, the plant cuticle supplements comprise a plurality of components, e.g., the compositions can be made from at least three, at least four, at least five, or at least six, at least seven, at least eight, or at least nine different components. Components are compounds or formulations of compounds that provide functionality to the composition, and when a given component is present in a composition, it can include one or more compounds that provide the functionality. For example, if a preservative component is included in a composition, the preservative component can include one or more compounds that act as a preservative and optionally one or more excipients.

In one aspect, the invention provides a plant cuticle supplement.

In certain embodiments, the plant cuticle supplement, comprises:
(a) a cellulose component;
(b) one or more oils comprising medium or long chain fatty acids;
(c) one or more non-ionic surfactants;
(d) a protic organic solvent; and
(e) potassium bentonite.

The cellulose component that makes up from 0.001% to 25% or about 6% (representative embodiment). The cellulose component is either microcrystalline cellulose, cellulose fibers, or a combination thereof. A representative embodiment uses microcrystalline cellulose. Cellulose fibers may substitute some of the microcrystalline cellulose and act to thicken the formulation. An alternative is hemp fiber.

In certain embodiments, the cellulose component is microcrystalline cellulose, cellulose fibers, or a combination thereof. In certain of these embodiments, the cellulose fibers have a size of about 0.1 μm to about 1,000 μm, about 0.1 μm to about 500 μm, about 0.1 μm to about 200 μm, about 0.1 μm to about 150 μm, or about 0.1 μm to about 100 μm. In certain embodiments, the cellulose component is a microcrystalline cellulose and further comprises pectin. Without being bound to theory, it is believed that in this embodiment, the microcrystalline cellulose is the matrix of the cuticle supplement and that pectin crosslinks those cellulose fibers resulting in strengthening of the coating much the same as cutin in the naturally occurring plant cuticle. It is further believed that the medium and long chain fatty acids co-polymerize with the cellulose and pectin matrix to provide a contiguous film that covers the plant completely.

In certain embodiments, the medium or long chain fatty acids is an oil comprising one or more C8-C20 fatty acids (e.g., C8, C10, and/or C12 fatty acids). In other embodiments, the oils comprising medium or long chain fatty acids is safflower oil, palm oil, or a combination thereof.

Medium and/or long chain fatty acids that makes up from 0.001% to 45% or 5% to 45% of the formulation. In a representative embodiment, medium and/or long chain fatty acids make up 32.5%. The fatty acids are believed to copolymerize with the cellulose component and form the backbone of the product. During making the product “pops” and oils no longer separate out. C8, C10, and C12 fatty acids are preferred fatty acids for water retention. Safflower oil may provide water retention and palm oil may provide thickness and both provide hydrophobicity.

In certain embodiments, the plant cuticle supplement further comprises decaglyceryl-10-oleate. Decaglyceryl-10-oleate is an agent for inhibiting syneresis and may be added in an amount from 0.001 to 5%, or about 0.8%. Decaglyceryl-10-oleate stops syneresis of oil from the product.

In certain embodiments, the one or more surfactants is a non-ionic surfactant, an amphoteric surfactant, or a combination thereof. Representative non-ionic surfactants include isopropyl myristate, polysorbate, polysiloxane (Sylcoat), and combinations thereof. In certain of these embodiments, the non-ionic surfactant is polysiloxane/Sylcoat (2-(3-hydroxypropyl)-heptamethyl-trisiloxane, ethoxylated acetate or polysiloxane) and may be present in an amount from 0/001% to 25%, 0/1% to 15%, or about 7.4% (representative embodiment). The amphoteric surfactant may make up from 0.001% to 15%, or 0.1% to 12%, or about 9% (representative embodiment). In certain embodiments, the amphoteric surfactant component is lecithin.

The surfactant or combination of surfactants that provide flowability and make up from 0.001% to about 45%. The surfactants may be isopropyl myristate and polysorbate. Isopropyl myristate is an example of a surfactant that imparts flowability to the product. In certain embodiments, isopropyl myristate may make up from 0.001% to 45%, 0.1 to 25%, or about 17% of the formulation (representative embodiment). Polysorbate may make up from 0.001% to 15%, 0.001% to 12%, or about 8.5% (representative embodiment). Alternatives include polysorbate 20, 40, 60, and 80.

The plant cuticle supplements disclosed herein comprise a protic organic solvent (e.g., methanol, ethanol, acetic acid). In some embodiments, the plant cuticle supplements comprise a non-aqueous solvent component. The solvent can be present in any amount needed to prepare the compositions. In some embodiments, the solvent is present is an amount ranging from about 0.001% to about 40% by weight. In certain embodiments, the cuticle compositions comprise the organic solvent in an amount of about 5%, about 7.5%, about 10%, about 15%, or about 20% by weight. A particularly suitable solvent is ethanol, such as 200-proof ethanol. In some embodiments, ethanol is used to solubilize other components of the cuticle composition. In some embodiments, certain components of the cuticle compositions are suspended in ethanol. Ethanol or other suitable organic solvent can act a preservative component to prevent fungal and bacterial cultures from growing in the cuticle supplement. Representative protic organic solvents include ethanol, propanol, isopropanol, acetic acid, propionic acid, and combinations thereof.

The plant cuticle supplement of the invention includes potassium bentonite. Potassium bentonite acts as a bulking component and to impart the formulation with sunburn protection functionality. Potassium bentonite may also contribute to an aesthetically pleasing matte effect. Potassium bentonite may make up an amount of the formulation from 0.001% to 20%, 1% to 8%, or about 3.7% (representative embodiment). Potassium bentonite does not swell so the product does not thicken excessively and becomes non-flowable. Sufficient thickening can be obtained by using pectin.

In certain embodiments, the plant cuticle supplement further includes hemicellulose or pectin. Pectin is a crosslinking reagent that strengthens the cuticle supplement, reduces/decelerates water movement (across the cuticle) that makes up 0.001% to 12% of the formulation. Below 5% is preferred and 1.2% is used in a representative embodiment. In certain embodiments, the pectin/cellulose ratio is 1:5, which mimics what is found in a cell wall. Pectin may contribute to the thickness of the product.

In certain embodiments, the plant cuticle supplement further comprises β-apo-8′-carotenal. β-Apo-8-carotenal is used in formulations that provide protection against scalding or physiological browning. β-Apo-8′-carotenal is a powerful antioxidant that does not break down in heat or light so is an excellent substitute for vitamin E (tocopherol or tocotrienol). β-Apo-8-careotenal may make up an amount of the formulation from 0.001% to 55, 0.1% to 2%, or about 0.4% (representative embodiment).

In certain embodiments, the plant cuticle supplement further comprises a preservative.

In certain embodiments, the plant cuticle supplement further comprises glycerol monostearate. Glycerol monostearate may be used as an emollient and for aesthetic purposes (bloom effect), as it contributes to a non-gloss matte appearance of certain fruit and berries (e.g., grapes, blueberries, and raspberries). Glycerol monostearate may be added in amounts from 0.001% to 10%, or 0.1% to 10%, or about 4.5% (representative embodiment).

In certain embodiments, the plant cuticle supplement further comprises glycerol. Glycerol may be added to improve the performance of the formulation. Glycerol may reinforce the structure of the formulation, perhaps by forming a triglyceride with the fatty acid backbone, which may make the product “rain tight”. Therefore, in certain embodiments, the ratio of fatty acid to glycerol is 3:1. Glycerol may make up from 0.001% to 15%, 0.1% to 8%, of about 5% (representative embodiment).

In certain embodiments, the plant cuticle supplement is non-aqueous.

In one embodiment, the plant cuticle supplement comprises ethanol, isopropyl myristate, Polysorbate 80, safflower oil, glycerol, decaglyceryl-10-oleate, lecithin, β-apo-8′-carotenal, palm oil, glycerol monostearate, microcrystalline cellulose, pectin, Sylcoat, and potassium bentonite.

A representative plant cuticle supplement of the invention consists of ethanol, isopropyl myristate, Polysorbate 80, safflower oil, glycerol, decaglyceryl-10-oleate, lecithin, β-apo-8′-carotenal (or vitamin E), palm oil, glycerol monostearate (GMS), microcrystalline cellulose, pectin, Sylcoat, and potassium bentonite.

This following is a representative plant cuticle composition of the invention listing the ingredients and amounts in percent by weight as function of final composition volume for PBC1322.

| Ingredient | 100 ml | 1 Gal | 2 Gal | 4 Gal |
|---|---|---|---|---|
| Ethanol | 10.2 | 385 | 770 | 1540 |
| Isopropyl myristate | 16.9 | 640 | 1280 | 2560 |
| Polysorbate 80 | 8.5 | 320 | 640 | 1280 |
| Safflower oil | 17.4 | 660 | 1320 | 2640 |
| Glycerol | 4.8 | 180 | 360 | 720 |
| Lecithin | 9.0 | 340 | 680 | 1360 |
| β-Apo-8′-carotenal/Vit E | 0.4 | 15 | 30 | 60 |
| Palm Oil | 9.2 | 350 | 700 | 1400 |
| GMS | 4.4 | 165 | 330 | 660 |
| Microcrystalline Cellulose | 5.9 | 225 | 450 | 900 |
| (Creafiber 150) | | | | |
| Pectin | 1.2 | 45 | 90 | 180 |
| Polysiloxane | 7.4 | 280 | 560 | 1120 |
| (Sylcoat) | | | | |
| Potassium bentonite | 3.7 | 140 | 280 | 560 |
| TOTAL | 100.0 | 3785 | 7570 | 15140 |

The following is a procedure for making a representative plant cuticle supplement of the invention.
1) Weight out the palm oil in glass beaker or metal pot. Heat the palm oil to 100° C.
2) Weigh out the other ingredients but weigh out ethanol last.
3) In a large mixing pot, add ethanol, isopropyl myristate, polysorbate 80, safflower oil, glycerol, decaglyceryl-10-oleate, and β-apo-8-carotenal (or vitamin E) in soybean oil and mix thoroughly at 500 rpm.
4) Fold the lecithin in slowly and start heating the mixture from room temperature to 52° C.
5) Add the melted palm oil from (1) before the temperature reaches 42° C.
6) Once the temperature of the mixture reaches 52° C. continue mixing until all the lecithin is dissolved and solution is a uniform brown color with no granular appearance. Ensure a vortex is formed in the mixing solution.
7) Add the glycerol monostearate and continue mixing until it is completely dissolved.
8) Increase the stirrer to 850 rpm and raise the temperature to 82° C.
9) Fold in the microcrystalline cellulose (Creafiber 150) slowly and ensure you do not get clumping.
10) Fold in the pectin slowly.
11) Add the polysiloxane (Sylcoat) and allow to mix until it is a uniform solution with all ingredients completely dissolved.
12) Fold in the potassium bentonite and ensure it is thoroughly mixed.
13) Raise the mixer shaft so that the vortex becomes a fountain and aerates the resultant parabolic wave.
14) After 30 min at 82° C. turn off the heat and allow the solution to cool back down to room temperature. Continue stirring at 850 rpm ensuring the fountain effect continues (This may require the mixing shaft be raised or lowered as the product cools)
15) As the product cools, it will co-polymerize and form a homogenous colloid that appears cream colored. This typically happens between 35° and 45° C.
16) Decant the final product into jugs as a pourable product even at room temperature.
17) Store at room temperature.

In another aspect, the invention provides aqueous compositions comprising the plant cuticle supplement as described herein. In certain embodiments, the aqueous composition includes the plant cuticle supplement in an amount ranging from about 0.01% to about 10% by volume, about 0.01% to about 5% by volume, about 0.1% to about 5% by volume, about 0.01% to about 2% by volume, or about 0.1% to about 2% by volume.

In certain embodiments, the aqueous composition is buffered. In certain of these embodiments, the buffer is a phosphate buffer (e.g., potassium phosphate buffer) to prevent phytotoxicity. In certain embodiments, the aqueous composition has a pH of about 4.0 to about 9.0. In other embodiments, the aqueous composition has a pH of about 6.0 to about 7.5. In further embodiments the aqueous composition has a pH of about 7.2 (physiological pH).

Upon application of an aqueous solution of the plant cuticle supplement, as described herein, to a plant or a plant part, the plant cuticle supplement forms an exogenous film thereon after expression of water and drying of the non-aqueous solution.

Additional components that may be further included in the plant cuticle supplement include the following.

### Preservative Component

In particular embodiments, the plant cuticle supplements disclosed herein comprise a preservative component. The preservative component is any compound or combination of compounds that can be used to increase the field or shelf life of the cuticle supplement or a plant or plant part comprising the film resulting from the application of the supplement, for example, fruits, flowers, and vegetables. The preservative component can be included in the cuticle composition in any concentration that is sufficient to increase the shelf life of the composition, the plant, or plant part treated with the composition, or the field life of the plant or plant part treated with the composition.

Preferably, the preservative component is present is an amount ranging from about 0.001% to about 40% by weight. Exemplary concentrations of preservative component in the cuticle compositions include from about 0.001% to about 40%, from about 0.01% to about 10%, from about 0.02% to about 9%, from about 0.05% to about 8%, from about 0.07% to about 7%, from about 0.10% to about 6%, and from about 0.15% to about 5% by weight.

Suitable preservative components include compounds of Table 1.

TABLE 1

| Exemplary preservative | Exemplary concentration |
|---|---|
| Ammonium caseinate | 0.001 to 10% |
| Ascorbyl palmitate | 0.001 to 10% |
| Ascorbyl stearate | 0.001 to 10% |
| Citrate salts (ammonium, calcium, sodium) | 0.0001 to 5% |
| Ethanol (200 proof) | 0.001 to 40% |
| L-cysteine (max = 0.5%) | 0.001 to 10% |
| Potassium sorbate | 0.001 to 10% |
| Vitamin E in soyabean oil (tocopherol) | 0.0001 to 20% |
| Sodium alginate (+potassium sorbate) | 0.0001 to 15% |
| Tocotrienols | 0.0001 to 20% |

### Surfactant Component

In particular embodiments, the plant cuticle supplements disclosed herein comprise a surfactant component, including non-ionic silicone surfactant components and amphoteric surfactant components. Surfactants are added to ensure the film does not bead up upon contact with plant or plant part, such as leaves or fruit. The preservative component can be included in the composition at any suitable concentration that is sufficient to achieve its function.

Preferably, surfactants are present is an amount ranging from about 0.001% to about 15% by weight. Exemplary concentrations of surfactants in the cuticle compositions include from about 0.001% to about 15%, from about 0.01% to about 10%, from about 0.02% to about 9%, from about 0.05% to about 8%, from about 0.07% to about 7%, from about 0.10% to about 6%, and from about 0.15% to about 5% by weight.

Suitable surfactant components include compounds of Table 2. In some embodiments, the cuticle supplements comprise both amphoteric and non-ionic surfactant components. Preferably, the amphoteric surfactant is lecithin. A particularly useful non-ionic component is a silicone surfactant, e.g., SylCOAT™.

TABLE 2

| Exemplary surfactant | Exemplary concentration |
|---|---|
| Lecithin | 0.001 to 15% |
| Polysorbate 80 | 0.001 to 15% |
| SylCOAT ™ | 0.001 to 15% |
| Diteric | 0.0001 to 15% |
| Egg yolk | 0.0001 to 15% |
| 1-Hexadecanaminium, N-(carboxymethyl)- | 0.0001 to 15% |
| N,N-dimethyl, inner salt | |
| Lauryl betaine | 0.0001 to 15% |

### Film Enhancing Component

In some embodiments, the plant cuticle supplements disclosed herein comprise a film enhancing component. The “film enhancing component” is any compound or mixture of compounds that enhances film spreading. Exemplary ingredients that can be used as film enhancing components include potassium silicate, calcium silicate, aluminum magnesium silicate, aluminum calcium silicate, magnesium silicate, aluminum sodium silicate, aluminum potassium silicate, aluminum sodium potassium silicate, magnesium trisilicate, silica, silicic acid and it salts, siloxanes, dimethicone copolyol, dimethicone copolyol fatty acid esters or ethers, silicone glycol copolymer, other water soluble silicates, isopropyl myristate, isopropyl palmitate, butyl stearate, diisopropyl adipate, diacetyl adipate, dibutyl adipate, dioctyl adipate, glyceryl adipate, myristyl myristate, oleic acid, soybean oil, vegetable oil, ethyl oleate and combinations thereof.

### Antioxidant Component

In some embodiments, the plant cuticle supplements disclosed herein comprise an antioxidant component. The “antioxidant component” is a component that prevents or slows down oxidative damage to the compositions or plants and plant parts comprising film resulting from the application of the compositions. In some embodiment, antioxidants protect post-harvest fruit and vegetables from browning caused by oxidation. The antioxidants can be included at a concentration of from about 0.01 to about 1.0% by weight. One of ordinary skill in the art will be able to determine the appropriate concentration of antioxidant component needed for a specific purpose.

Exemplary antioxidants include EDTA, glutathione, alpha-tocopherol, tocopherols, vitamin E, vitamin E acetate, vitamin E palmitate, zinc glycinate, ascorbic acid and its salts of calcium, sodium, and potassium, ascorbyl palmitate, calcium citrate, BHA, BHT, guaiac extract, gallic acid and methyl, ethyl, propyl, dodecyl esters of gallic acid, phosphatidylcholine, propionic acid, sucrose, cyclodextrins, rosemary, and cysteine hydrochloride. Particularly useful antioxidants include vitamin E, ascorbyl palmitate, ascorbyl stearate, and combinations thereof. Table 3 provided below contains some additional exemplary antioxidants and their exemplary concentrations.

TABLE 3

| Exemplary antioxidant component | Exemplary concentration |
|---|---|
| Ascorbyl palmitate | 0.001 to 10% |
| Ascorbyl stearate | 0.001 to 10% |
| Beta-carotene | 0.0001 to 10% |
| β-Apo-8′-carotenal | 0.0001 to 10% |
| Cysteine | 0.0001 to 10% |
| Ellagic acid | 0.001 to 5% |
| Gallic acid | 0.001 to 5% |
| Glutathione | 0.0001 to 5% |
| Glycine | 0.0001 to 5% |
| Leucine | 0.0001 to 5% |
| Lysine | 0.00001 to 10% |
| Oxalic acid | 0.0001 to 20% |
| Tocotrienols | 0.0001 to 15% |
| Ubiquinol | 0.0001 to 10% |
| Vitamin E in soybean oil (Tocopherol) | 0.0001 to 20% |

### Humectant Component

In some embodiments, the plant cuticle supplements disclosed herein comprise a humectant component. A humectant is a component that helps spread film resulting from the application of the compositions and keeps the supplement pliable.

The humectants can be included at a concentration of from about 0.01 to about 25% by weight. Exemplary concentrations of humectant components that can be used in the compositions include from about 0.001% to about 25%, from 0.01% to about 20%, from about 0.01% to about 15%, from about 0.01% to about 10%, from about 0.05% to about 9%, from about 0.10% to about 7%, from about 0.10% to about 6%, and from about 0.15% to about 5% by weight. One of ordinary skill in the art will be able to determine the appropriate concentration of humectant component needed for a specific purpose.

Exemplary humectants include compounds of Table 4. A particularly suitable humectant for the preparation of the cuticle supplement compositions disclosed herein is glycerol.

TABLE 4

| Exemplary humectant component | Exemplary concentration |
|---|---|
| Agar | 0.001 to 5% |
| Alginic acid | 0.001 to 2% |
| Beeswax | 0.01 to 55% |
| Calcium chloride | 0.001 to 15% |
| Collagen | 0.01 to 25% |
| Diteric | 0.0001 to 25% |
| Gelatin | 0.001 to 15% |
| Glycerol | 0.001 to 25% |
| Hyaluronic acid | 0.001 to 20% |
| Lecithin | 0.001 to 25% |
| Polysorbate 20 | 0.001 to 20% |
| Sorbitol | 0.0001 to 15% |
| Pyrrolidone carbonic acid | 0.0001 to 25% |

### Emollient Component

In some embodiments, the plant cuticle supplements disclosed herein comprise an emollient component. An emollient is a compound or mixture of compounds that can be added to facilitate spread of the film.

In some embodiments, the emollients can be included in the compositions disclosed herein at a concentration of from about 0.01 to about 45% by weight. Exemplary concentrations of emollient component include from about 0.001% to about 45%, from 0.01% to about 35%, from about 0.01% to about 31%, from about 1% to about 30%, from about 0.05% to about 15%, from about 0.10% to about 10%, from about 0.10% to about 6%, and from about 0.15% to about 5% by weight. One of ordinary skill in the art will be able to determine the appropriate concentration of emollient component needed for a specific purpose.

Exemplary emollients include compounds of Table 5. In some embodiments, particularly suitable emollients for the preparation of the cuticle supplements disclosed herein are safflower oil and palm oil.

TABLE 5

| Exemplary emollient component | Exemplary concentration |
|---|---|
| Beeswax | 0.001 to 45% |
| Borax | 0.0001 to 5% |
| Cetyl alcohol | 0.0001 to 15% |
| Cyclomethicone | 0.0001 to 15% |
| Dimethicone | 0.0001 to 15% |
| Fractionated coconut oil | 0.0001 to 40% |
| Glycerol | 0.0001 to 25% |
| Lanolin | 0.0001 to 15% |
| Palm oil | 0.0001 to 25% |
| Petrolatum | 0.0001 to 15% |
| Safflower oil | 0.0001 to 45% |
| Sunflower oil | 0.0001 to 45% |
| Tocopherol | 0.0001 to 15% |

### Bloom Effect Component

In some embodiments, the plant cuticle supplements disclosed herein comprise bloom effect component. A bloom effect component is a compound or mixture of compounds that can be added to achieve or maintain the necessary bloom effect on a plant part, such as fruit. Inclusion of a bloom effect component is particularly advantageous for cuticle supplement compositions used in crops which require a bloom on the fruit, e.g., blueberry and wine grape.

In some embodiments, the bloom effect component can be included in the compositions disclosed herein at a concentration of from about 0.0001% to about 15% by weight. Exemplary concentrations of bloom effect component include from about 0.001% to about 15%, from 0.01% to about 15%, from about 0.01% to about 10%, from about 1% to about 15%, from about 0.05% to about 10%, from about 0.10% to about 5%, from about and from about 0.5% to about 5% by weight. One of ordinary skill in the art will be able to determine the appropriate concentration of bloom effect component needed for a specific purpose.

Exemplary bloom effect components include compounds of Table 6. In some embodiments, particularly suitable bloom effect component is glycerol monostearate.

TABLE 6

| Exemplary bloom effect component | Exemplary concentration |
|---|---|
| Borax | 0.0001 to 5% |
| Glycerol monostearate | 0.0001 to 15% |

### Occlusive Agent Component

In some embodiments, the plant cuticle supplements disclosed herein comprise an occlusive agent component. An occlusive agent component is a compound or mixture of compounds helps create a hydrophobic barrier to prevent the movement of water.

In some embodiments, an occlusive component can comprise compounds selected from oils, silicones, waxes, and combinations thereof. Preferably, the occlusive agent component is palm oil.

In some embodiments, the occlusive agent component can be included in the compositions disclosed herein at a concentration of from about 0.0001% to about 45% by weight. Exemplary concentrations of occlusive agent component include from about 0.001% to about 45%, from 5% to about 15%, from about 0.01% to about 15%, from about 1% to about 15%, from about 0.05% to about 10%, or from about 0.10% to about 5% by weight. A non-inclusive list of useful occlusive agents and their exemplary concentrations is provided in Table 7.

TABLE 7

| Exemplary occlusive agent component | Exemplary concentration |
|---|---|
| Vegetable oils | 0.0001 to 45% |
| Waxes (e.g., palm oil, beeswax) | 0.0001 to 45% |
| Silicones | 0.0001 to 15% |

### Thickening Agent Component

In some embodiments, the plant cuticle supplements disclosed herein comprise a thickening agent component. A thickening agent component is a compound or mixture of compounds that can be added to prevent the final composition from separating out during storage.

In certain embodiments, a thickening agent component can be included in the compositions disclosed herein at a concentration of from about 0.0001% to about 15% by weight. Exemplary concentrations of thickening agent component include from about 0.001% to about 15%, from 5% to about 15%, from about 0.01% to about 15%, from about 1% to about 15%, from about 0.05% to about 10%, or from about 0.10% to about 5% by weight.

In some embodiments, a thickening agent component can comprise compounds selected from the compounds of Table 8 and combinations thereof. Preferably, the occlusive agent component is calcium bentonite.

TABLE 8

| Exemplary thickening agent | Exemplary concentration |
|---|---|
| Albumin | 0.0001 to 15% |
| Attapulgite | 0.0001 to 15% |
| Arrowroot/tapioca | 0.0001 to 15% |
| Calcium bentonite | 0.0001 to 15% |
| Carrageenan (max 0.15%) | 0.0001 to 15% |
| Casein | 0.0001 to 15% |
| Collagen | 0.0001 to 15% |
| Diatomaceous earth | 0.0001 to 15% |
| Egg yolk | 0.0001 to 15% |
| Iota carrageenan | 0.0001 to 15% |
| Kappa carrageenan | 0.0001 to 15% |
| Kudzu powder | 0.0001 to 15% |
| Lambda carrageenan | 0.0001 to 15% |
| Locust bean gum (glucomannan) | 0.0001 to 15% |
| Mucilage/sago starch | 0.0001 to 15% |
| Sodium bentonite | 0.0001 to 15% |
| Yoghurt | 0.0001 to 15% |

### Fragrance Component

In some embodiments, the plant cuticle supplements disclosed herein comprise a fragrance component.

In certain embodiments, a fragrance component can be included in the compositions disclosed herein at a concentration of from about 0.0001% to about 20% by weight. Exemplary concentrations include from about 0.001% to about 15%, from 5% to about 15%, from about 0.01% to about 15%, from about 1% to about 15%, from about 0.05% to about 10%, or from about 0.10% to about 5% by weight. One of ordinary skill in the art will be able to determine the appropriate concentration of fragrance needed for a specific purpose.

In some embodiments, a fragrance component can comprise compounds selected from the compounds of Table 9 and combinations thereof.

TABLE 9

| Exemplary fragrance | Exemplary concentration |
|---|---|
| Butyl anthranilate | 0.0001 to 10% |
| Dimethyl anthranilate | 0.0001 to 20% |
| Eugenol | 0.0001 to 20% |
| Peppermint oil | 0.0001 to 20% |
| Thyme oil | 0.0001 to 20% |

### Plasticizer Component

In other embodiments, the compositions disclosed herein comprise a plasticizer component. Suitable exemplary plasticizers include compounds of Table 10 and mixtures thereof and can be added to the composition in the amount of 0.0001% to 25% by weight.

TABLE 10

| Exemplary plasticizers | Exemplary concentration |
|---|---|
| Beta-cyclodextrin | 0.0001 to 15% |
| Benzyl acetate | 0.0001 to 5% |
| Citric acid | 0.0001 to 15% |
| Epoxidized soybean oil | 0.001 to 25% |
| Glycerol triacetate | 0.0001 to 15% |
| Triethyl citrate | 0.0001 to 15% |

In some embodiments, other components that can be added to the cuticle supplement composition include behenic acid (0.0001% to 25%), for example, as a wax component for shine and disease prevention; lignin (0.0001% to 25%) for sunburn protection; ascorbyl palmitate (0.0001% to 20%), tocotrienols (0.0001% to 20%), and ammonium citrate (0.0001% to 20%) for prevention of postharvest browning reactions.

### Components for Control of Spotted Wing Drosophila (SWD)

In some embodiments, the cuticle supplement comprises one or more of components for control of spotted wing drosophila (SWD).

Examples of such suitable components include thyme oil (0.0001 to 20%), thiamine (0.0001 to 20%), panthenol (0.0001 to 20%), and calcium propionate (0.0001 to 20%), for repulsion of spotted wing Drosophila (SWD). In some embodiments, the cuticle supplements include one or more synthetic sugar, for example, erythritol (0.0001 to 20%), or sorbitol (0.0001 to 20%), to create an attractant to SWD that contains low nutrient status. In other embodiments, the cuticle supplements include potassium sorbate (0.0001 to 30% range) for control of spotted wing drosophila.

In some embodiments, the components of the compositions described herein are edible. In some embodiments, the components are selected from compounds and compositions that have a regulatory status of generally recognized as safe (GRAS) as provided by the United States Food and Drug Administration. In other embodiments, the components are listed on the Environment Protection Agency's 4A and 4B lists as being safe for the environment. In certain embodiments, each component of the cuticle supplement is GRAS. In other embodiments, each component of the cuticle supplement is on the Environment Protection Agency's 4A and 4B lists.

### Methods of Use of the Cuticle Supplement Compositions

The disclosure also provides methods of use of the cuticle supplements and plants and plant parts that contain exogenous films that are created by contacting the plant or plant part with the compositions described herein. The term “exogenous,” as used herein, is intended to distinguish “exogenous” films from natural films or cuticles produced by plants.

The term “plant” as used herein refers to a whole plant including any root structures, vascular tissues, vegetative tissues, and reproductive tissues. A “plant part” includes any portion of the plant. For example, upon harvesting a tree, the tree separated from its roots becomes a plant part. Plant parts also include flowers, fruits, leaves, vegetables, stems, roots, branches, and combinations thereof that are less than the whole plant.

### Application of the Cuticle Supplement Compositions

The cuticle compositions described herein can be applied to plants and plant parts using any method that allows the desired surface area to be contacted with the composition. The plant or plant part need not be covered completely with the composition to achieve the desired benefits. Preferably, the plant cuticle compositions are diluted with water to form an aqueous composition comprising the plant cuticle supplement in an amount ranging from about 0.1% to about 10%. The resulting aqueous formulation can be applied to a plant or plant part using any conventional methods. In certain embodiments, the plant or plant part is contacted with the aqueous composition described above, wherein upon drying of the composition an exogenous film is formed on the plant or a plant part. In some embodiments, the contacting comprises spraying the aqueous composition onto the plant or plant part, dipping the plant or plant part into the aqueous composition, enrobing the plant or plant part with the aqueous composition, or a combination thereof.

In some embodiments, the application of the cuticle supplement composition to the plant, plant part (e.g., fruits, vegetables, flowers, leaves, stems) results in formation of an exogenous film thereon. The term “film” as used herein refers to the creation of a layer on the plant or plant part. The layer does not need to be of uniform thickness or completely homogeneous in composition. Moreover, the film does not need to completely cover the object it is applied to. In some embodiments, the film covers only 10%, 20%, 30%, 40%, 50%, 60%, 70%, 80% or 90% of the surface area of the plant or plant part. In other examples, the thickness of the film varies by 10%, 20%, 30%, 40%, 50%, 60%, 70%, 80% or 90% over the object that is contacted with the film. In certain embodiments, these values vary by +5%.

In some embodiments, the thickness of the exogenous film is between about 0.1 μm and about 150 μm. In other embodiments, the thickness of the exogenous film is about 90 μm, about 100 μm, about 110 μm, or about 120 μm.

Plants and Plant Parts Treated with the Cuticle Supplement Compositions

Additionally, disclosed herein are plants and plant parts, comprising an exogenous film formed by contacting the plant or plant part with the aqueous solution of the cuticle compositions, wherein the exogenous film forms thereon after drying of the aqueous composition. In some embodiments, the exogenous film does not substantially alter the taste of the plant or plant part as compared to a substantially equivalent plant or plant part lacking the exogenous film. In other embodiments, the plant part is fruit. Preferred fruits include cherry, blueberry, and grape. In certain embodiments, the fruit has reduced cracking upon ripening as compared to a substantially equivalent fruit grown in substantially equivalent conditions but lacking the exogenous film. In yet other embodiments, the plant or plant part has increased post-harvest shelf life, increased cuticle strength, or a combination thereof as compared to a substantially equivalent plant in substantially equivalent conditions but lacking the exogenous film.

In certain embodiments, the plant or plant part has reduced pre-harvest susceptibility to fungal diseases, such as powdery mildew in cherries, apples and wine grapes, botrytis in wine grapes, and apple scab in apples.

### Water Consumption Reduction

In addition to the advantages described above, the compositions of the invention have other commercially important uses.

Provided herein is a method of reducing water consumption by a plant comprising contacting the plant with the aqueous composition comprising the plant cuticle supplement disclosed herein, wherein upon drying of the composition an exogenous film is formed on the plant thereby reducing water consumption by the plant. In some embodiments, the plant is apple, cherry, or grape. In certain embodiments, the water consumption is reduced by about 15%, by about 20%, by about 25%, by about 30%, or by about 50%. In some embodiments, the water consumption is reduced by greater than about 15%.

### Drosophila Egg Laying Reduction

In other embodiments, the invention provides a method of reducing egg laying of D. suzukii in a plant comprising contacting the plant with the aqueous compositions comprising the cuticle supplement disclosed herein, wherein upon drying of the composition an exogenous film is formed on the plant thereby reducing egg laying of D. suzukii in the plant. In certain embodiments, the egg laying is reduced about 60%, about 70%, about 80%, about 90%, or about 95%. Preferably, the plant is blueberry. In some embodiments, the reduction of egg laying is found up to 30 days after contacting the plant with the aqueous composition.

The ingredients of representative compositions of the invention (PBC-1320 and PBC-1322 are shown in Table 11 and 12, respectively.

TABLE 11
PBC 1320

| Ingredient | 100 ml | 1 Gal | 2 Gal | 4 Gal |
|---|---|---|---|---|
| Ethanol | 10.0 | 379 | 757 | 1514 |
| Isopropyl Myristate | 7.0 | 265 | 530 | 1060 |
| Polysorbate 80 | 9.0 | 341 | 681 | 1363 |
| Safflower | 20.0 | 757 | 1514 | 3028 |
| Glycerol | 5.0 | 189 | 379 | 757 |
| Lecithin | 10.0 | 379 | 757 | 1514 |
| Vit E | 2.0 | 76 | 151 | 303 |
| Palm Oil | 11.0 | 416 | 833 | 1665 |
| Glycerol monostearate | 5.0 | 189 | 379 | 757 |
| Microcrystalline cellulose | 5.0 | 189 | 379 | 757 |
| (Creafiber 90) | | | | |
| Pectin | 3.0 | 114 | 227 | 454 |
| Polysiloxane (Sylcoat) | 8.0 | 303 | 606 | 1211 |
| Calcium Bentonite | 5.0 | 189 | 379 | 757 |
| TOTAL | 100.0 | 3785.0 | 7570.0 | 15140.0 |

TABLE 12
PBC1322

| Ingredient | 100 ml | 1 Gal | 2 Gal | 4 Gal |
|---|---|---|---|---|
| Ethanol | 10.2 | 385 | 770 | 1540 |
| Isopropyl Myristate | 16.9 | 640 | 1280 | 2560 |
| Polysorbate 80 | 8.5 | 320 | 640 | 1280 |
| Safflower | 17.4 | 660 | 1320 | 2640 |
| Glycerol | 4.8 | 180 | 360 | 720 |
| Decaglyceryl-10-oleate | 1.1 | 40 | 80 | 160 |
| Lecithin | 9.0 | 340 | 680 | 1360 |
| β-Apo-8′-carotenal/Vit E | 0.4 | 15 | 30 | 60 |
| Palm Oil | 9.2 | 350 | 700 | 1400 |
| Glycerol monostearate | 4.4 | 165 | 330 | 660 |
| Microcrystalline cellulose | 5.9 | 225 | 450 | 900 |
| (Creafiber 150) | | | | |
| Pectin | 1.2 | 45 | 90 | 180 |
| Polysiloxane (Sylcoat) | 7.4 | 280 | 560 | 1120 |
| Potassium bentonite | 3.7 | 140 | 280 | 560 |
| TOTAL | 100 | 3785 | 7570 | 15140 |

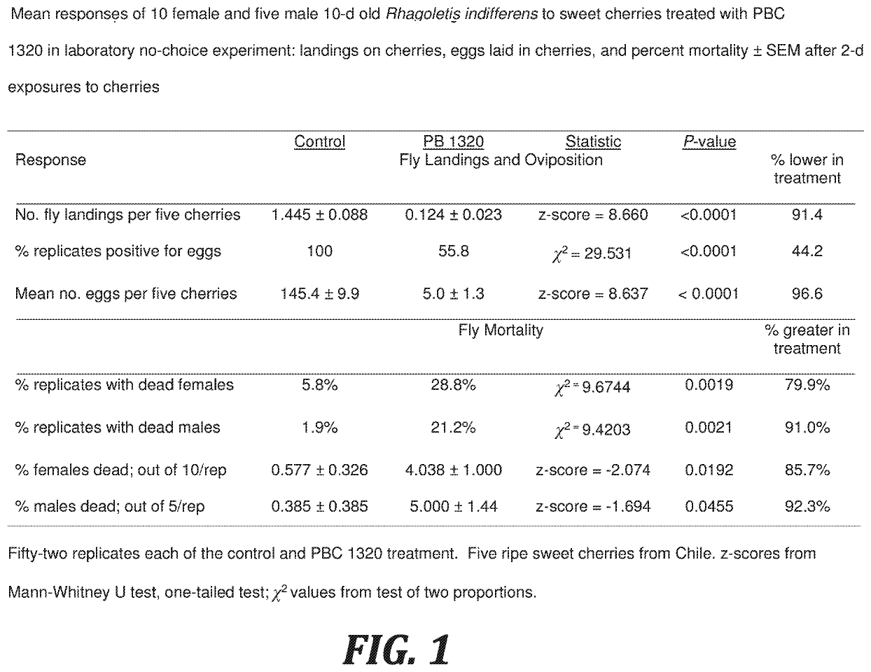

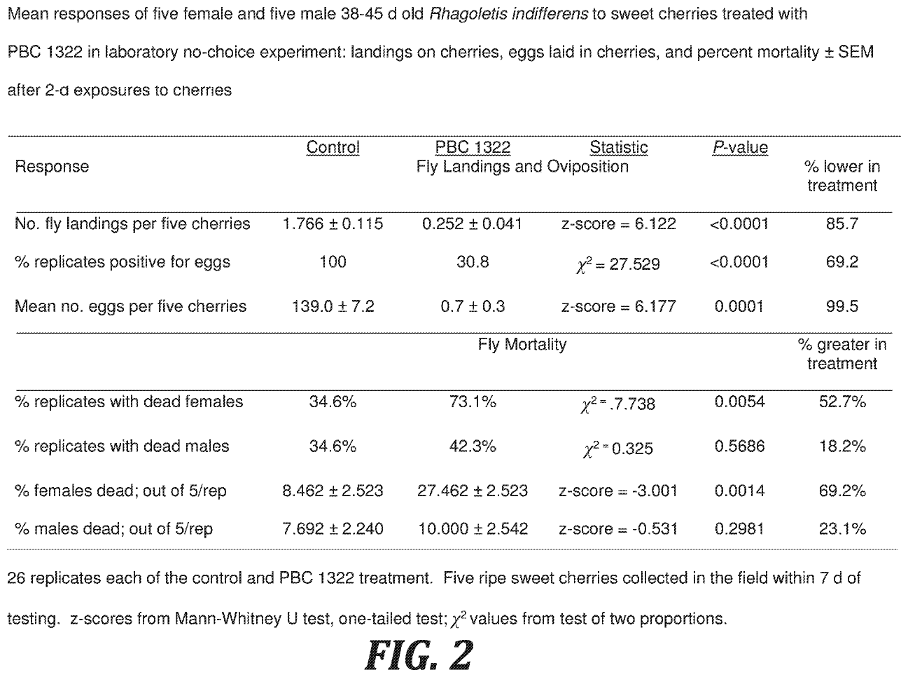

FIGS. 1 and 2 are tables that show the effectiveness of representative compositions of the invention (PBC-1320 and PBC-1322, respectively), in controlling Rhagoletis indifferens in sweet cherries.

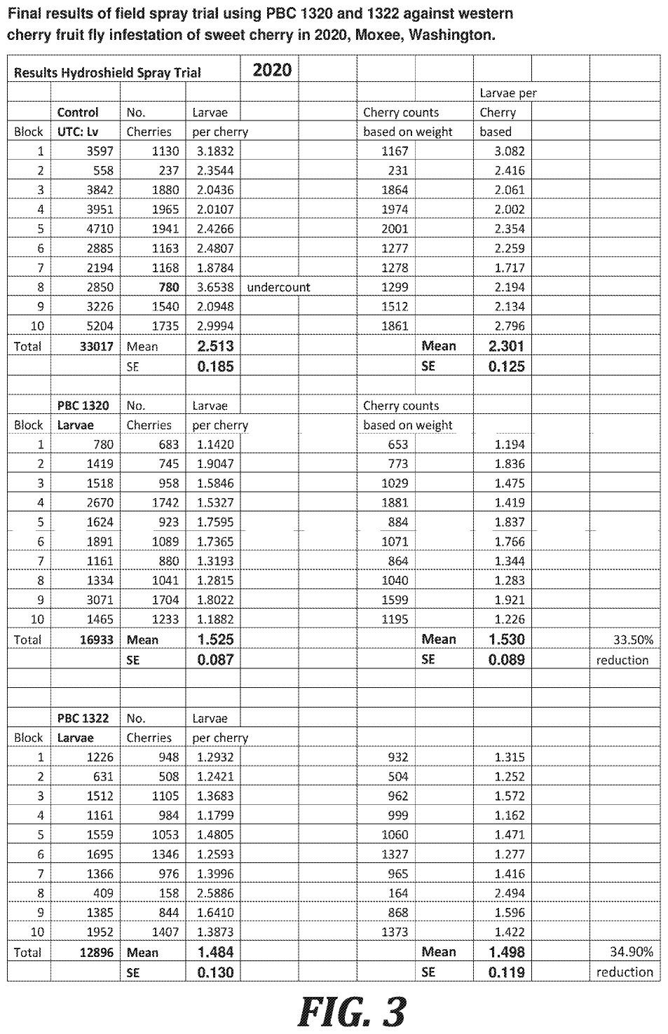

FIG. 3 is a table that summarizes the results of a field spray trial using PBC 1320 and 1322 against western cherry fruit fly infestation of sweet cherry.

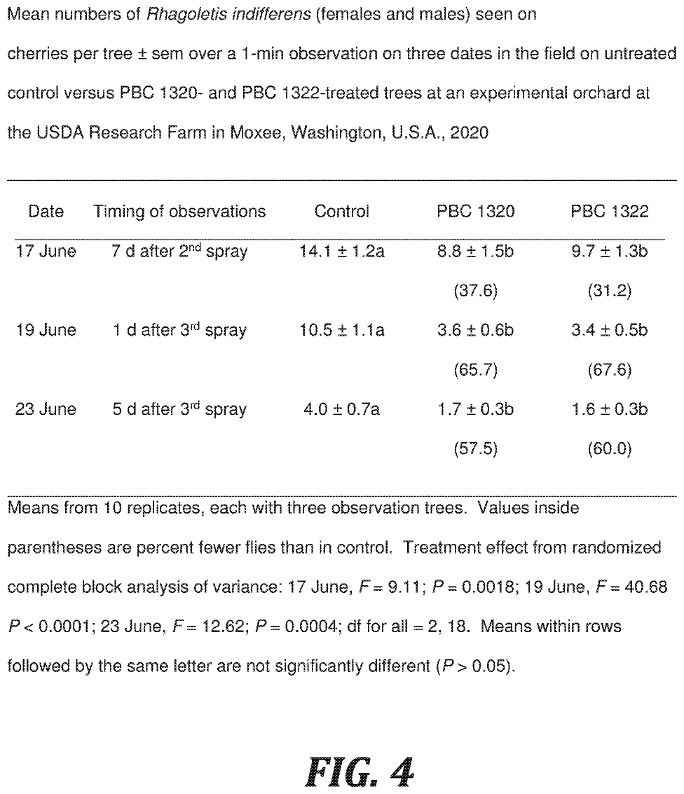

FIG. 4 is a table that shows the mean numbers of Rhagoletis indifferens (females and males) seen on cherries per tree over a 1-min observation on three dates in the field on untreated control versus PBC 1320- and PBC 1322-treated trees at an experimental orchard.

### Effects of PBC 1320 Field Sprays on Larval Infestations

In the 2020 field spray trial, PBC 1320 significantly reduced larval infestations in cherries versus the control by 31.8% (1.546+0.096 versus 2.268+0.087 larvae/cherry, respectively; no significant difference between treatments) (treatment effect: F=13.51; df=2, 19; P=0.0003).

As used herein, the term “about” refers to +5% of the specified value.

While illustrative embodiments have been illustrated and described, it will be appreciated that various changes can be made therein without departing from the spirit and scope of the invention.

1. A plant cuticle supplement, comprising:
(a) a cellulose component;
(b) one or more oils comprising medium or long chain fatty acids;
(c) one or more surfactants;
(d) a protic organic solvent; and
(e) potassium bentonite.

2. The plant cuticle supplement of claim 1, wherein the cellulose component is microcrystalline cellulose, cellulose fibers, or a combination thereof.

3. The plant cuticle supplement of claim 2, wherein the cellulose fibers have a size of about 0.1 μm to about 1,000 μm, about 0.1 μm to about 500 μm, about 0.1 μm to about 200 μm, about 0.1 μm to about 150 μm, or about 0.1 μm to about 100 μm.

4. The plant cuticle supplement of claim 1, wherein the cuticle supplement further comprises hemicellulose or pectin.

5. The plant cuticle supplement of claim 1, wherein the plant cuticle supplement is non-aqueous.

6. The plant cuticle supplement of claim 1, wherein the protic organic solvent is selected from the group consisting of ethanol, propanol, isopropanol, acetic acid, propionic acid, and combinations thereof.

7. The plant cuticle supplement of claim 1, wherein the plant cuticle supplement further comprises β-apo-8′-carotenal.

8. The plant cuticle supplement of claim 1, wherein the plant cuticle supplement comprises a preservative.

9. The plant cuticle supplement of claim 8, wherein the plant cuticle supplement further comprises glycerol monostearate.

10. The plant cuticle supplement of claim 1, wherein the one or more surfactants is selected from the group consisting of non-ionic surfactants, amphoteric surfactants, or a combination thereof.

11. The plant cuticle supplement of claim 10, wherein the non-ionic surfactant is isopropyl myristate, polysorbate, polysiloxane (Sylcoat), or a combination thereof.

12. The plant cuticle supplement of claim 10, wherein the amphoteric surfactant component is lecithin.

13. The plant cuticle supplement of claim 1, wherein the plant cuticle supplement further comprises glycerol.

14. The plant cuticle supplement of claim 1, wherein the one or more oils comprising medium or long chain fatty acids is an oil comprising one or more C8-C20 fatty acids.

15. The plant cuticle supplement of claim 1, wherein the one or more oils comprising medium or long chain fatty acids is safflower oil, palm oil, or a combination thereof.

16. The plant cuticle supplement of claim 1, wherein the plant cuticle supplement further comprises decaglyceryl-10-oleate.

17. The plant cuticle supplement of claim 1, wherein the plant cuticle supplement comprises ethanol, isopropyl myristate, Polysorbate 80, safflower oil, glycerol, decaglyceryl-10-oleate, lecithin, β-apo-8′-carotenal, palm oil, glycerol monostearate, microcrystalline cellulose, pectin, Sylcoat, and potassium bentonite.

18. (canceled)

19. An aqueous composition comprising the plant cuticle supplement of claim 1 in an amount ranging from about 0.01% to about 10% by volume, about 0.01% to about 5% by volume, about 0.1% to about 5% by volume, about 0.01% to about 2% by volume, or about 0.1% to about 2% by volume.

20-24. (canceled)

25. An exogenous film formed by on a plant or plant part, wherein the film is formed on the plant or plant part after drying the aqueous composition of claim 19 applied to the plant or plant part.

26. A method of reducing water consumption by a plant, comprising applying an aqueous composition of claim 19 to a plant or plant part, wherein upon drying of the aqueous composition on the plant or plant part, an exogenous film is formed on the plant or plant part thereby reducing water consumption by the plant.

27. A method of reducing egg laying of D. suzukii on a plant, comprising applying an aqueous composition of claim 19 to a plant or plant part, wherein upon drying of the aqueous composition on the plant or plant part, an exogenous film is formed on the plant or plant part thereby reducing egg laying of D. suzukii in the plant.
